(19) United States
(12) Patent Application Publication
(10) Pub. No.: US 2008/0216510 A1
(43) Pub. Date: Sep. 11, 2008

(54) Combined Cycle System For Gas Turbines and Reciprocating Engines and a Method for the Use of Air as Working Fluid in Combined Cycle Power Plants

(76) Inventors: David Vandor, Tarrytown, NY (US); Ralph Greenberg, Santa Rosa, CA (US)

Correspondence Address: LAW OFFICE OF MICHAEL A. BLAKE, 112 BROAD STREET, MILFORD, CT, 06460, US

(21) Appl. No.: 11/843,309

(22) Filed: Aug. 22, 2007

Related U.S. Application Data
(60) Provisional application No. 60/823,110, filed on Aug. 22, 2006.

(51) Int. Cl. F25J 1/00; F02C 7/00

(52) U.S. Cl. 62/600; 60/783

(57) ABSTRACT

A combined cycle power plant comprising: a first cycle comprising: a prime mover; a prime mover exhaust in fluid communication with the prime mover; a second cycle comprising: a liquid air supply; a heat exchanger in fluid communication with the liquid air supply and the prime over exhaust; a turbo expander in fluid communication with the heat exchanger; wherein liquid air is heated to gaseous air by the heat exchanger, and the gaseous air is expanded in the turbo expander thereby producing work. A liquid air combined cycle method comprising: providing pressurized liquid air; heating the pressurized liquid air to pressurized gaseous air; expanding the pressurized gaseous air with a turbo expander; using work from the expansion of the pressurized gaseous air to compress ambient air; heating the expanded pressurized gaseous air; sending the heated expanded air to a turbine combustion chamber; and using waste heat from a turbine to heat pressurized liquid air. A liquid air combined cycle method comprising: providing pressurized liquid air; heating the pressurized liquid air to pressurized gaseous air; expanding the pressurized gaseous air with a turbo expander; using work from the expansion of the pressurized gaseous air to drive a generator; and using waste heat from a prime mover to heat pressurized liquid air.

### CROSS-REFERENCES

The present application claims the benefit of provisional patent application No. 60/823,110, filed on Aug. 22, 2006 by David Vandor and Ralph Greenberg.

### TECHNICAL FIELD

The disclosures made herein relate generally to combined cycle systems, and more particularly, where the prime mover may be a gas turbine or a reciprocating engine and where the heat recovery portion of the combined cycle uses liquid air as the working fluid. Instead of water/steam or organic fluids, air is selected because it has several important advantages over other working fluids.

### BACKGROUND

Major power production equipment makers (such as GE or Siemens) seek to find incremental improvements in standard combined cycle systems by, for example, improving the turbine blade's resistance to heat, and thus allowing the use of hotter gas streams. Some makers, (such as Solar) offer recuperated gas turbines that improve their efficiency. Others seek to capture the “wasted” energy in the heat of the exhaust from small turbines in Organic Rankine Cycles (ORC) that do not use steam boilers but instead use a substitute working fluid. None of these alternatives now yield significant efficiencies and most are uneconomical at smaller scales, say, under 50 MW This is also true of reciprocating engines, which tend to be used at much smaller outputs, say up to 1 MW per reciprocating engine. Thus, there are very few (if any) practical ways to create combined cycle power plants using reciprocating engines as the prime mover.

The capital and operating costs of ORC and Stirling Cycles, relative to power output, limit their deployment. Wind, geothermal, pumped power, photovoltaic, and fuel cells have limited “efficiency” and siting constraints. By contrast, natural gas combined cycle power plants have a proven track record, offering the lowest emission per KWH of all fossil fuels and allowing deployment to locations served by natural gas pipelines and/or to Landfill Gas (LFG) and other non-pipeline sites. Reciprocating engines are commonly used to produce power at LFG sites, but with very few that recover the extensive amount of waste heat that is generated by the reciprocating engine (in the exhaust and in the jacket water), which is not turned into power.

Gas turbines expend as much as 75% of their power output to compress combustion air. This work is done in the “front end” of the turbine. Standard combined cycle power plants use the “waste” exhaust heat from the prime mover (the turbine) to produce additional power by way of a steam cycle. However, waste-heat driven steam cycles are not more than 35% efficient. Thus, the maximum efficiency of existing combined cycles is not more than 60%. Standard combined cycles tend to be uneconomical at less than 20 MW of output. In most jurisdictions, steam cycles require that an on-site “steam engineer” be present during the entire time the steam cycle operates. That condition is one of the many reasons that smaller combined cycle power plants, with turbines as the prime mover, are not economically viable. The problem is even more acute for reciprocating engines.

Therefore, a combined cycle power plant, (with turbines or reciprocating engines as the prime mover), that overcome the above listed and other disadvantages is desired.

### SUMMARY

The disclosed invention relates to a combined cycle gas turbine system comprising: a compressor; a motor in operational communication with the compressor; a molecular sieve in fluid communication with the compressor; a first heat exchanger in fluid communication with the molecular sieve; a vessel in fluid communication with the first heat exchanger; a cryogenic pump in fluid communication with the vessel and the first heat exchanger; a second heat exchanger in fluid communication with the first heat exchanger; a turbo-expander in fluid communication with the second heat exchanger, and in operational communication with the compressor; a gas-fired heater in fluid communication with the turbo-expander; a gas turbine in fluid communication with the gas-fired heater, and in fluid communication with the second heat exchanger; an expander portion of a gas turbine in operational communication with a generator, and in electrical communication with the motor; a natural gas supply in fluid communication with the gas turbine.

The disclosed invention also relates to a combined cycle system comprising: a liquid air storage tank in fluid communication with a pump; a first heat exchanger in fluid communication with the pump; a second heat exchanger in fluid communication with the first heat exchanger; a cryogenic expander in fluid communication with the first heat exchanger; a third heat exchanger in fluid communication with the second heat exchanger; a fifth heat exchanger in fluid communication with the second heat exchanger and the third heat exchanger; a first compressor in fluid communication with the second heat exchanger; a second compressor in fluid communication with the second heat exchanger and the cryogenic expander and the fifth heat exchanger; an inter-cooler in fluid communication with both the first compressor and second compressor; an exhaust flue in fluid communication with the third heat exchanger; a fourth heat exchanger in fluid communication with the third heat exchanger, and the fifth heat exchanger; a hot gas expander comprising a first stage hot gas expander and a second stage hot gas expander, the first stage hot gas expander in fluid communication with the third heat exchanger and the fourth heat exchanger, and the second stage hot gas expander in fluid communication with the third heat exchanger; a prime mover in fluid communication with the fourth heat exchanger; a driven piece of equipment in operational communication with the prime mover; a natural gas supply in fluid communication with the prime mover; and the cryogenic expander in operable communication with the first compressor and the second compressor.

In addition, the disclosed invention relates to a combined cycle power plant comprising: a first cycle comprising: a prime mover; a prime mover exhaust in fluid communication with the prime mover; a second cycle comprising: a liquid air supply; a heat exchanger in fluid communication with the liquid air supply and the prime over exhaust; a turbo expander in fluid communication with the heat exchanger; wherein liquid air is heated to gaseous air by the heat exchanger, and the gaseous air is expanded in the turbo expander thereby producing work.

Also, the disclosed invention relates to a liquid air combined cycle method comprising: providing pressurized liquid air; heating the pressurized liquid air to pressurized gaseous air; expanding the pressurized gaseous air with a turbo expander; using work from the expansion of the pressurized gaseous air to compress ambient air; heating the expanded pressurized gaseous air; sending the heated expanded air to a turbine combustion chamber; and using waste heat from a turbine to heat pressurized liquid air.

Additionally, the disclosed invention relates to a liquid air combined cycle method comprising: providing pressurized liquid air; heating the pressurized liquid air to pressurized gaseous air; expanding the pressurized gaseous air with a turbo expander; using work from the expansion of the pressurized gaseous air to drive a generator; and using waste heat from a prime mover to heat pressurized liquid air.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a process diagram of the disclosed combined cycle gas turbine system;

FIG. 2 is a process diagram of another embodiment of the disclosed combined cycle gas engine system;

FIG. 3 is a flow chart illustrating one embodiment of the disclosed method; and

FIG. 4 is a flow chart illustrating another embodiment of the disclosed method.

### DETAILED DESCRIPTION

The inventors have developed an alternative to standard combined cycle power plants. For Combined Cycles where a turbine is the prime mover, The Vandor Compressed Air (VCA) cycle overcomes the limitations outlined above by “un-bundling” the three elements of the Brayton Cycle —1) the gas compressor, 2) the mixing chamber, and 3) the expander; thus improving the efficiency of compressing combustion air, and allowing for a more efficient use of exhaust gases. The VCA cycle will not use steam to produce more power than a stand-alone gas turbine would. (Thus it will not require a full time on-site steam engineer.) Instead, the VCA cycle will warm a high-pressure stream of liquid air, converting it by phase shift to “compressed air” at the pressure and temperature required by the gas turbine, eliminating the need for the turbine to compress its own air.

The extra power generated by the gas turbine (because it will not compress air) will significantly exceed the power required to liquefy air in the first place because the refrigeration energy (“coldness”) stored in the liquid air will be continuously recovered as the pumped, high-pressure dense-phase air is expanded to the high-pressure warm vapor state required by the turbine.

Exhaust heat will be more efficiently used to expand “pumped” liquid air than to produce steam. The combined efficiencies of the VCA cycle will yield approximately 50% more power per unit of natural gas fuel, at lower capital costs. The increased power output per unit of fuel will result in a substantial reduction of emissions per KWH of output. The lower capital, operating and fuel costs will yield lower power costs.

The inventors foresee significant energy efficiency improvements to small- and mid-scale combined cycle plants, possibly attaining about 67% efficiency. By contrast, the most sophisticated (large scale) combined cycle plants come close to about 60% efficiency. Thus the VCA cycle may yield a more than about 11% gain in efficiency, but even at much smaller scales. In addition, those efficiency improvements will not be offset by higher capital or operating costs. Indeed, we foresee the VCA combined cycle plant to be less costly than a standard combined cycle plant (at any equivalent size) because the VCA version will not have a steam cycle. Also, most jurisdictions require full-time operators for steam cycles, but not for non-steam heat recovery systems.

Standard combined cycle power plants use Brayton Cycle gas turbines as the prime mover, and recovered exhaust heat in a steam cycle. Power generation by the expansion and condensation of steam is a “mature” technology with efficiencies limited to about 35% for the steam cycle portion of the combined cycle. Despite the complexity of the standard combined cycle, the efficiency of the most advanced designs does not exceed about 60%. For example, a 100 MW combined cycle power plant will produce about 75 MW via the gas turbine and about 25 MW by way of the steam cycle. However, the turbine “wastes” some 100 MW of potential power in compressing the combustion air that it uses to produce the 75 MW. The majority of the power output derived from the burning of the natural gas is not converted to power.

The limited efficiency of the standard gas-fired combined cycle combined with the higher cost of natural gas result in a lack of competitiveness with other power sources, such as coal and nuclear for “base load” applications. On the lower end of the power spectrum, combined cycle power plants are too complex and costly to offer cost-effective solutions for distributive generation at less than, say, 50 MW.

By increasing the efficiency of combined cycles, (reducing the fuel used per KWH of output and yielding proportional emission reductions); and by reducing capital and operating costs, the VCA design will increase the competitiveness of gas-fired power generation and expand the viable range for combined cycles down to, say, 10 MW, with turbines as the prime mover, and down to 1 MW, with reciprocating engines as the prime mover.

Preliminary calculations indicate that the maximum theoretical Carnot Efficiency of the VCA cycle is about 75%. We project that the practical efficiency of the VCA cycle may approach about 70%. If that goal is reached, then the VCA cycle will be some 16% more efficient than the most sophisticated existing combined cycle power plant, significantly advancing power production technology. The deployment of high-efficiency VCA combined cycle power plants will be especially beneficial in reducing power costs and emissions, and expanding the potential for distributive generation.

The increased efficiencies, reduced fuel costs and lower capital and operating cost per KW of rated output will yield significantly lower lifecycle costs, allowing combined cycle configurations to extend their market reach deeper into (smaller scale) industrial and distributive power generation applications.

Advantages to the disclosed invention include the fact that air (the source of the liquid air) is free (less costly than even water is), abundant, available everywhere (water/steam is not always available), is not toxic, causes no harm upon release (compared to ammonia, hydrocarbon working fluids), is non-explosive (compared to hydrocarbons), thus if there are small leaks or unintended escapes of the air, it will do no harm and is not expensive to replace.

With respect to thermodynamics, we seem to find evidence that liquid air is more efficient than other liquids as a working fluid for heat recovery in combined cycles, no matter what the prime mover. Air is the ideal working fluid in a Rankine cycle because the source of heat (prime mover waste heat) can be absorbed and utilized at the high temperature (900 F-1,000 F) of availability while being rejected at low cryogenic temperatures. By contrast Rankine cycles using other working fluids (such as water and various hydrocarbons) are limited to heat rejection at near ambient temperatures.

In the VCA cycle, using air as the working fluid in the heat recovery portion of the cycle, heat can be rejected at the relatively low temperature of condensing air (−260 F to approximately −300 F). The temperature range between absorption and rejection of heat results in a higher thermal efficiency (ratio of power generated to heat absorbed).

The disclosed combined gas cycle system may use any suitable fuel for the prime mover (turbine or reciprocating engine). Most turbines use natural gas, although the disclosed invention is able to work with turbines that use propane and other hydrocarbons. Most reciprocating engines use diesel fuel, or gasoline, but some are designed to run on natural gas or propane, and such engines would fall within the scope of the disclosed invention.

Bio-diesel, (alone or mixed with standard diesel), and ethanol mixed with gasoline, are other fuel options for the prime mover. The VCA combined cycle, with turbines or reciprocating engines, will achieve substantial efficiencies irrespective of the fuel used by the prime mover.

The present applications is focused on power plants, from 1 MW up to 50 MW, however, the scope of the invention includes ranges above 50 MW. The lower limit may be less than 1 MW, and will depend on the value of the power produced, the cost and availability of fuel, and the cost of the additional equipment required to achieve the extra (combined cycle) power output.

Although the disclosure discusses stationary power plants, the invention may be suitable for mobile applications, such as but not limited to ship power plants, locomotives power plants, truck power plants, bus power plants and even automobile power plants. The economic viability of the invention for mobile applications will depend on the cost and availability of fuel, the cost of the additional equipment required to achieve the extra power output, and the sensitivity of the “vehicle” to the extra room and weight required to achieve the combined cycle.

The fuel efficiency savings of the VCA combined cycle will yield proportional emission reductions. The absolute amount of emissions will be the same as the prime mover's emissions, without a combined cycle. However, the emissions per KWH of power output will be reduced in proportion to the fuel saved per KWH of output. In some contexts, the reduced emissions (including that of CO₂) will be as economically significant as the reduced fuel use and/or the increased power output for the same amount of fuel used.

The VCA cycle need not only be an OEM product, sold by existing makers of power plants. It can also be used in retrofit applications. This is especially advantages at existing power plants that need to have their total output increased, without fully replacing the entire power plant, such as third world generators and off-the grid power plants. The VCA cycle will allow existing power plants to substantially reduce their emissions (per KWH of output), by retrofitting the VCA system.

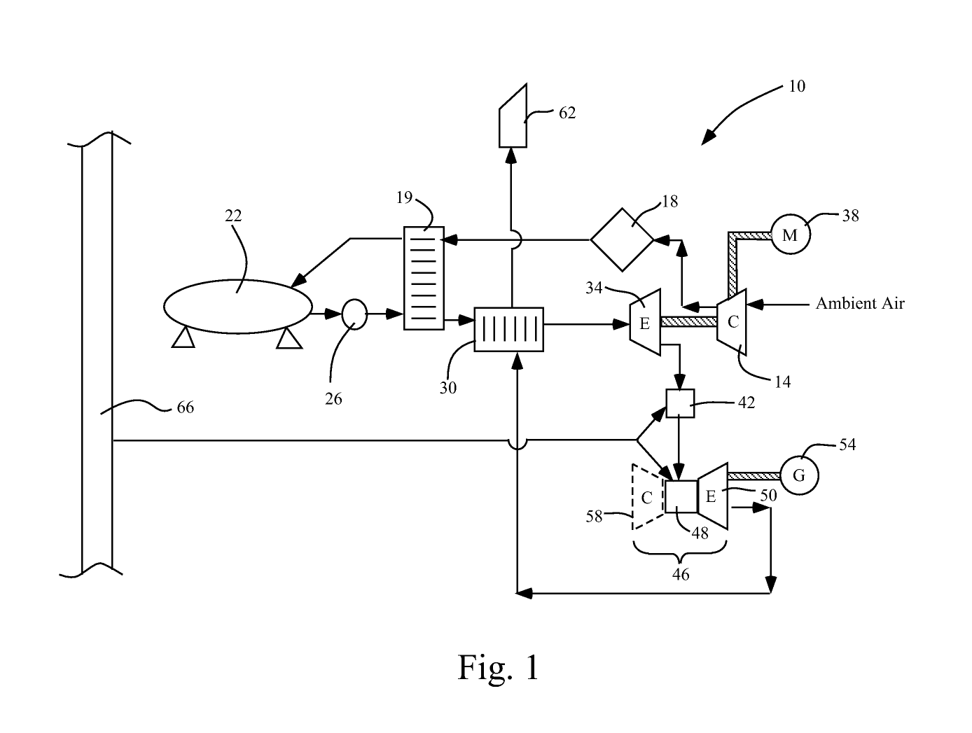

FIG. 1 is a process diagram of the combined cycle gas turbine system 10. Ambient air will be compressed in a compressor 14. The compressor 14 may be any suitable compressor, including but not limited to a multi-stage inter-cooled gear compressor (independent of the prime mover). The ambient air will be compressed to between about 125 psi to about 350 psi. That is a lower pressure and requires less work than if done in the front end of a gas turbine, and will be accomplished more efficiently in the inter-cooled compressor. In that sense, the VCA design “deconstructs” the Brayton Cycle, allowing for the optimum compression of the combustion air, which is not sent directly to the turbine's combustion chamber. The compressed air will be sent through a molecular sieve 18 to remove water and CO2, thus “drying” it in preparation for deep refrigeration. This drying step is relatively low-tech and well understood in the gas processing industry. The air, now at about 125 psi to about 350 psi air will be sent through a heat exchanger 18 where it is liquefied by counter-flowing, high-pressure liquid air. That heat exchange warms and vaporizes the liquid air “outflow” (from a low-pressure cryogenic tank), on its way to the turbine. The compressed, cleaned and chilled inflow air will be delivered as a liquid to an insulated cryogenic buffer vessel 22. “Flashing” of the compressed and chilled air will further reduce its temperature and allows for the optimum compression energy required at the compressor 14 due to the energy it receives from the expander 34. The flashing will produce air at about −290° F. (or colder) liquid air at atmospheric pressure; with a small portion being vented as warm air, after cold recovery. The outflow liquid air will be pumped to an appropriate pressure, including up to a supercritical state of about 2,000 psi by a cryogenic pump 26 prior to its trip through the heat exchanger 18. Because liquids are generally incompressible, pumping requires very little energy; achieving the optimum pressure (which may be about 2000 psi) with much less energy input than would be required for warm air compression. Vaporized, high-pressure air will exit the heat exchanger 18 at approximately 60° F. This air will be warmed to approximately 650° F. by heat exchange in the heat exchanger 30, where the air is warmed by the turbine 46 exhaust. The hot, high-pressure air will be expanded in a turbo-expander 34. The turbo-expander drives the compressor 14. A small fraction of the power produced by the gas turbine 46 via the generator 54 will provide supplemental power via a motor 38 to the compressor 14, if required. The expanded air will exit the expander 34 colder and will be warmed by additional hot (about 700° F. to about 800° F.) exhaust gas and/or a supplemental gas-fired heater 42. All of the exhaust heat will be available for warming the airflow, because none will be used for a “steam” cycle. In configurations where supplemental heating will be needed, the extra fuel used will be a small portion of the fuel savings achieved by the VCA cycle. The warmed (about 600° F.) about 155 psi to about 500 psi air (depending on the prime mover's design) will be sent to the combustion chamber 48 of the gas turbine 46 in lieu of its own compressor's product, and mixed with natural gas in the normal way to allow for combustion of the mixture, yielding hot, high-pressure combustion gases that are expanded by the expander 50 side of the gas turbine 46 to drive a generator 54 that produces the end product—electricity. Once the hot, compressed air is delivered to the mixing chamber. The gas turbine 46 will operate in the usual way, but yield significantly more power because it will not be compressing air using its compressor 58. In a retrofit application the front (compressor 58) end of the gas turbine 46 would be de-coupled. In a new construction version, the turbine would be purchased without a front end, substantially reducing its cost. The exhaust will be as clean as in ordinary combined cycle power plants, but because less fuel will be used relative to the total power output, the emissions per KWH will be lower. The hot exhaust gases (about 200° F.) will exit the heat exchanger 30, where the exhaust will vented through a flue 62. The flue 62 may be configured to maintain an outlet temperature of about 200° F. Natural gas may be supplied by a pipeline 66, or from a storage vessel, to the combustion chamber 48. Natural gas may also be used to fuel the heater 42.

The net power output for a standard combined cycle system may be about 6 MW using a rated 4.6 MW gas turbine. Using the disclosed VCA cycle, the net power output for the same rated 4.6 MW gas turbine may be as high as about 10.6 MW. This gain in output is achieved substantially by the fact that the compressor 58 of the gas turbine 46 is not required to compress air and that the waste exhaust heat is recovered, not in an inefficient steam cycle but in warming the pressurized air flow after it gives up its coldness to the counter-flowing compressed ambient air.

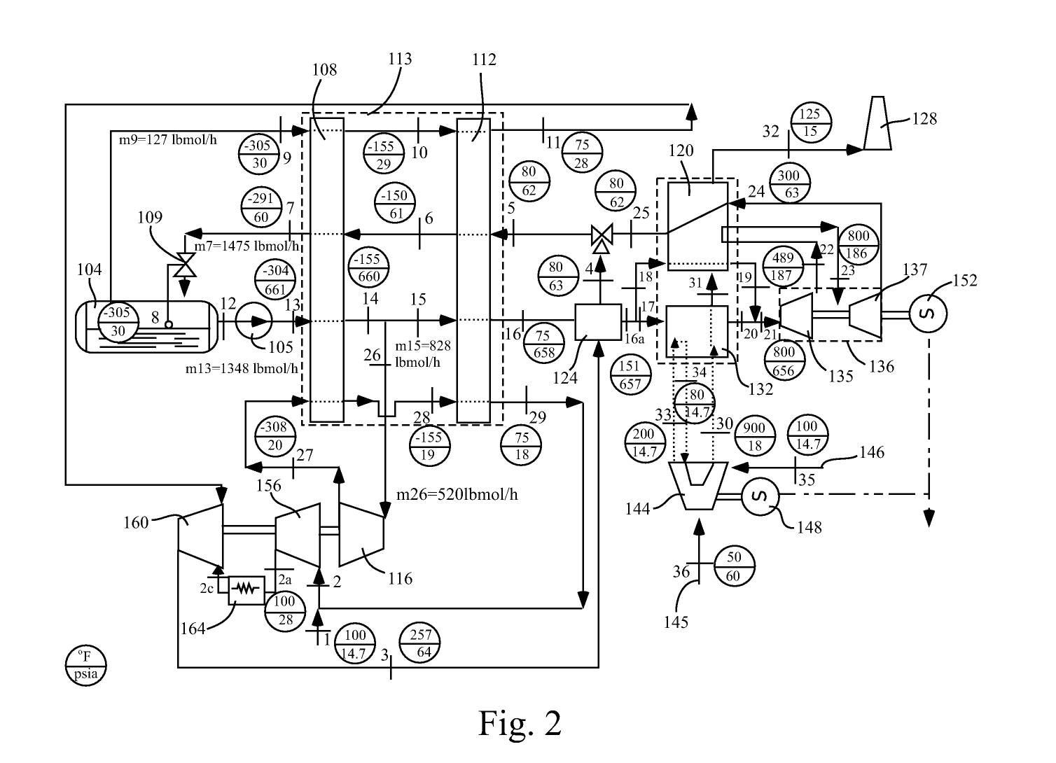

FIG. 2 shows another embodiment 100 of the disclosed a process diagram of the combined cycle gas turbine system. In this process diagram, circles with an upper number and a lower number written in them represent the temperature in ° F. (upper number) and pressure in psia (lower number) at an adjacent numbered point in the process diagram. For example at point 10, the temperature of the fluid is about −155° F. at a pressure of about 29 psia. Flow rates at certain numbered points in the process diagram are also indicated, for example at point 9, the flow rate “m9” is shown as being equal to about 127 lb mol per hour. Of course, one of ordinary skill in the art will recognize that all temperatures, pressures, flow rates may be changed depending upon the size of machinery, and desired process rates, and will still fall within the bounds of the disclosed invention.

Still referring to FIG. 2, a liquid air storage tank 104 is in fluid communication with a pump 105. The pump 105 is in fluid communication with a first heat exchanger 108. The first heat exchanger 108 is in fluid communication with a second heat exchanger 112, and a cryogenic expander 116. The second heat exchanger 112 is in fluid communication with a third heat exchanger 120, a fifth heat exchanger 124, a first compressor 156, and a second compressor 160. The second heat exchanger is also in fluid communication with the cryogenic expander 1 16. The third heat exchanger 120 is in fluid communication with an exhaust flue 128, the fifth heat exchanger 124, a fourth heat exchanger 132, a first stage 135 of a hot gas expander 136 and a second stage 137 of a hot gas expander 136. The fourth heat exchanger 132 is also in fluid communication with the fifth heat exchanger 124, and the first stage 135 of the hot gas expander 136, and a gas-fired reciprocating engine 144 or a reciprocating engine using any other fuel. The reciprocating engine 144 may be in operational communication with a first generator 148 or a piece of driven machinery. The gas turbine may be in communication with a natural gas supply 145 and an air supply 146. The hot gas expander 136 may be in operational communication with a second generator 152 or piece of driven machinery. The second compressor 160 is also in fluid communication with the fifth heat exchanger 124. The first compressor 156 may be in fluid communication with the second compressor 160 via an inter-cooler 164. The cryogenic expander 116 may be in operable communication with the first compressor 156 and the second compressor 160, and in fact, may drive both compressors 156, 160. The cryogenic expander 116, the first compressor 156, and the second compressor 160 may share the same drive shaft 161.

The combined cycle engine system may operate as follows. Liquid air is stored in the liquid storage tank 104. The tank 104 may store liquid air at about −305° F. and about 30 psia. The liquid air in the tank 104 is pumped via the pump 105 to about 661 psia and delivered to the first heat exchanger 108 where the liquid air from the tank 104 cools counter-flowing stream of air that is coming from the second heat exchanger 112. The counter-flowing stream of air will enter the first heat exchanger at about −150° D and about 61 psia. This counter-flowing stream of air will replace the amount of liquid air that was withdrawn from tank 8 and sent to the first heat exchanger 108. Once the counter-flowing stream of air exits the first heat exchanger 108, it will be at about −291° F. and about 60 psia and have a flow rate of about 1475 lb mol/hour. The about −155° F., and about 660 psia air (now a vapor) is split into two streams after point 14. One stream is sent through point 26 to the cryogenic expander 116 for cooling, exiting at point 27, at about −308° F. and low pressure (about 20 psia), serving as a refrigeration source in the first heat exchanger 108 to help cool the return stream that moves from point 6 to point 7. The low pressure (somewhat warmed) air that went from point 27 to point 28 is further used to cool more of the return stream that moves from point 5 to 6. By point 29, this relatively small stream of warm, low pressure air has given up much to all of its “coldness” and is now in need of recompression, moving through two stages of compression at the first compressor 156 and second compressor 160. The compressors 156, 160 act as a “load” on the cryogenic expander 116. It is this “loading” that produces work, which causes the outflow stream at point 27 to be cold. Points 2a and 2c show an inter-cooler 164 where some of the heat of compression from the first compressor 156 is wasted.

The outflow steam from the second compressor 160 is warm (due to the heat of compression) so it is used to warm the main air stream in the fifth heat exchanger 124 that has traveled from the liquid air tank 104 through the first and second heat exchangers 108, 112 on its way to the hot gas expander 136 where it will produce power.

Once the low-pressure warm air has given up its heat at the fifth heat exchanger 124, it joins the low-pressure return stream that will move through the second heat exchanger 112 and first heat exchanger 108 back to the liquid air tank 104.

The main air stream having been warmed at the fifth heat exchanger 124 moves on to the fourth heat exchanger 132 and third heat exchanger 120 (in split streams) where the air is further warmed by waste heat from the prime mover 144, which in this embodiment is a standard reciprocating engine. We show engine jacket water as the heat source for the fourth heat exchanger 132 and some exhaust gas as well, and exhaust gas as the only heat source for third heat exchanger 120. By the time the exhaust gas reaches point 32, it is fairly cool, but not so cold as to form liquid acids that would fall out if it were colder. The arrangement of heat recovery from the engine jacket water and the exhaust gas may vary, depending on engine size, engine efficiency, the chemical composition of the engine water (for example, its glycol content) and available heat exchangers at the appropriate size and cost. Persons of ordinary skill in the art will be able to optimize such heat recovery sub-systems, without materially altering the basic principles of the invention.

The very hot, high-pressure air moves from point 21 through the first stage 135 of the hot gas expander 136, with some heat recovery through the third heat exchanger 120, and then on to the second stage 137 of the expander 136, exiting still fairly hot, but at low-pressure. The about 300° F. air at about 63 psia is sent through the third heat exchanger 120 to recover some warmth, (warming the flow from point 18 to point 19), and then back toward the second heat exchanger 112 for chilling, and on to the first heat exchanger 108 for further chilling, so that it reaches point 7 at about −291 F and about 60 psia. Passing through a throttle valve 109, the air becomes liquid air at about −305° F. and about 30 psia, but producing some “flash gas”. The flash is shown moving up to point 9 and through first and second heat exchangers 108, 112 for “cold recovery”, and then on to the second compressor 160 for re-compression.

The first heat exchanger 108 and second heat exchanger 112 may comprise single heat exchanging unit 113.

If the base kW output of the reciprocating engine is assumed to be about 1.0 MW, then using the disclosed VCA cycle, the system recovers the waste heat of the engine and uses it to “boil” the liquid air at high pressure, and send it through a two-stage expander 136, which is generator 152 loaded, yielding another about 0.9 MW of net power. This “combined cycle” produces about a total of 1.9 MW, with no additional fuel use, raising the thermal efficiency of the stand-alone engine from about 30% to more than about 60%. In other words, you can achieve nearly twice as much power output with the same amount of fuel, or the same power output with half as much fuel. In any event the emissions per kWH of power output will be approximately 50% of that of the stand-alone engine.

The process diagram shown in FIG. 2 may be changed slightly near the turbine and so that the hot jacket water and the hot exhaust gas may be differently routed, depending on the characteristics of the desired system and reflecting the locally suitable water-to-glycol ratio of the jacket water.

One of ordinary skill in the art will recognize that the system may be tuned to yield different temperatures and pressures at various points along the cycle, and different mass flow rates than now shown. In addition, the process diagrams of FIGS. 1 and 2, or high level diagrams, that do not show all the various valves, pumps, meters, etc, that one of ordinary skill would understand the system may need.

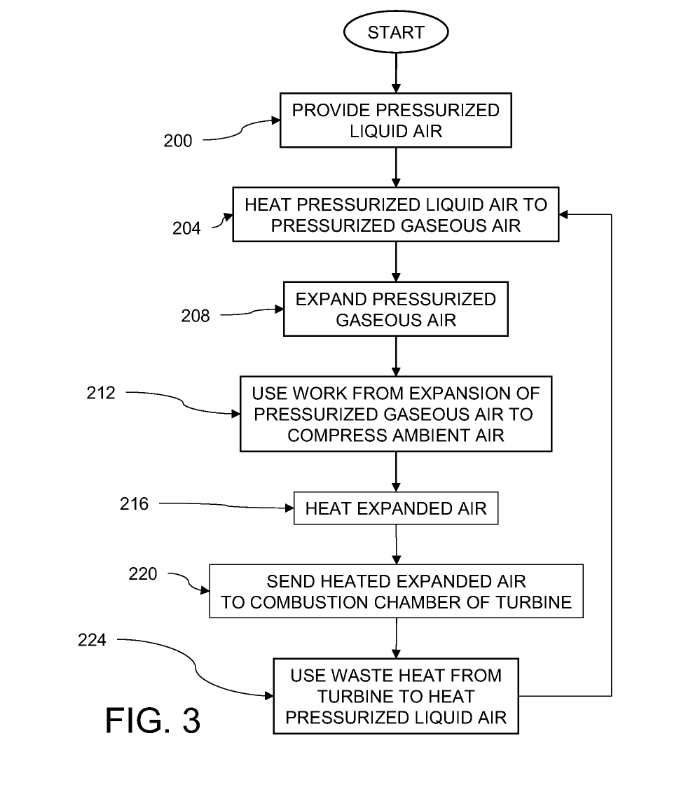

FIG. 3 is a flowchart illustrating a disclosed method. At act 200, the system provides pressurized liquid air. At act 204 the pressurized liquid air is heated to pressurized gaseous air. The heating may be accomplished by one or more heat exchangers. At act 208, the pressurized gaseous air is expanded by a turbo expander. At act 212 work from the expansion of the pressurized gaseous air is used to compress ambient air. The expanded air is heated at act 216. This act may be accomplished by using waste heat from the turbine to heat the expanded air, or it may be accomplished by using a heater, such as, but not limited to a gas fueled heater. At act 220 the heated expanded air is sent to the combustion chamber of the turbine. This act removes the need of a compressor stage for the turbine, thus increasing the efficiency of the system. At act 224, waste heat from the turbine is used to heat pressurized liquid air.

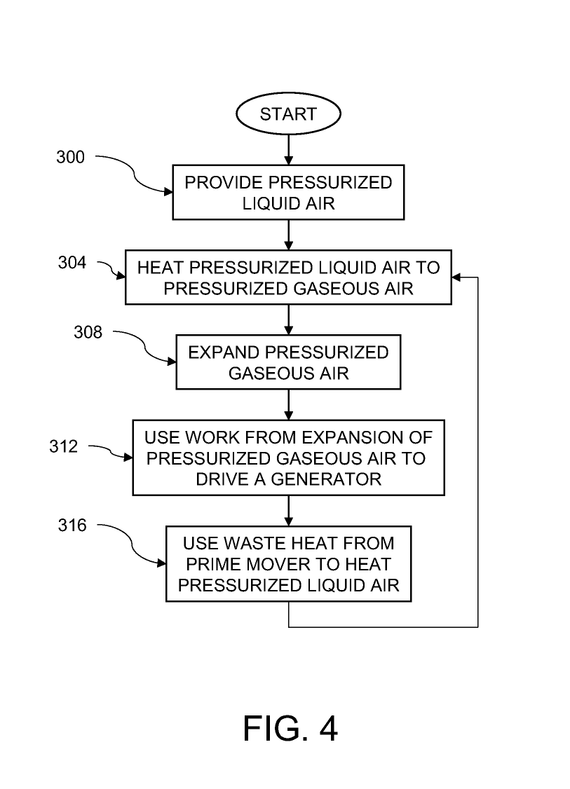

FIG. 4 is a flowchart illustrating a disclosed method. At act 300, the system provides pressurized liquid air. At act 304 the pressurized liquid air is heated to pressurized gaseous air. The heating may be accomplished by one or more heat exchangers. At act 308, the pressurized gaseous air is expanded by a turbo expander. At act 312 work from the expansion of the pressurized gaseous air is used to drive a generator. At act 316, waste heat from the prime mover is used to heat pressurized liquid air.

The disclosed system and method may be practiced via a variety of embodiments, some of which are described below.

The disclosed system and method uses air in a novel fashion. The use of air, as it shifts phase from a cryogenic liquid (liquid air) to a hot, high-pressure gas (compressed air), as a working fluid in the second (heat recovery) portion of a combined cycle power plant, having any prime mover (engine or turbine) as the first cycle, and using any fuel in the prime mover (gas, liquid or solid), where recovered waste heat from the prime mover is used to boil pumped liquid air, converting it to high-pressure, hot, compressed air, which drives a mechanical device, producing work or electric power.

Another embodiment of the novel use of air in the disclosed invention is the use of liquid air as a source for high-pressure compressed air for absorbing the waste heat from the prime mover (engine or turbine) in a combined cycle power plant, where the liquid air's phase is shifted to compressed air and where such a phase shift allows the air to act as a working fluid in the heat recovery portion of the combined cycle power plant, transferring the energy inherent in the high-pressure, hot, compressed air that resulted from the “boiling” of pumped liquid air, into kinetic energy, such as by hot gas expanders, to produce power.

Another system embodiment encompasses a combined cycle power plant with a turbine prime mover (which uses any fuel), where the work required by the turbine's front-end compressor is eliminated (yielding significantly greater work output at the generator-loaded end), because, in lieu of having the turbine expend substantial work to compress its own air intake, high-pressure, hot, compressed air is sent directly to the turbine's combustion chamber, where that stream is the result of the vaporization of pumped-to-pressure liquid air (hence the combined cycle because air compression occurs outside the turbine), where the heat source for that vaporization is the waste exhaust heat from the turbine, and where replacement liquid-air is provided by an expander-loaded compressor that sends ambient, dry, compressed air back to storage as a counter-flowing stream to be cooled by the out-flowing very-cold air, and where additional power for compression is supplied by a motor which is driven by a relatively small portion of the extra power output of the prime mover, where the compressed air sent to the turbine is in balance with the make-up stream that replaces the liquid air outflow.

The disclosed system invention also encompasses a combined cycle power plant with an engine prime mover (which uses any fuel), where the work performed by the engine is significantly enhanced by recovery of waste exhaust gas and jacket water heat, which are used to vaporize pumped-to-pressure liquid air, and where the resultant high-pressure, hot, compressed air is sent to a multi-stage turbo-expander that drives a second generator (hence the combined cycle), and where replacement liquid-air is provided by the return stream from the multi-stage expander, which returning air is cooled by the out-flowing very-cold air, and where make-up refrigeration is provided by a compressor-loaded cryogenic expander that deeply chills a small portion of the out-flowing vaporized somewhat cold air that has given up its “coldness” to the incoming air stream, such that the total waste heat output from the engine is in balance with the total flow of pumped-to-pressure liquid air, which is in balance with the returning flow of expanded air and with the flow within the make up refrigeration loop.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. For example, in FIG. 1, the outflowing compressed air, after it leaves the heat exchanger 18, can be “conditioned” by the addition of vaporized moisture, thus raising its mass/weight, and thus increasing the total energy output from the expander 34. Also, the pressures of the inflowing and outflowing air may be optimized (based on the analysis of “cooling curves) so that the compressed air operates at optimum pressures. Similarly, variations of exhaust heat temperatures (in turbines made by different makers) can be adjusted for by the optimal use of supplemental heat. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A combined cycle gas turbine system comprising:
a compressor;
a motor in operational communication with the compressor;
a molecular sieve in fluid communication with the compressor;
a first heat exchanger in fluid communication with the molecular sieve;
a vessel in fluid communication with the first heat exchanger;
a cryogenic pump in fluid communication with the vessel and the first heat exchanger;
a second heat exchanger in fluid communication with the first heat exchanger;
a turbo-expander in fluid communication with the second heat exchanger, and in operational communication with the compressor;
a gas-fired heater in fluid communication with the turbo-expander;
a gas turbine in fluid communication with the gas-fired heater, and in fluid communication with the second heat exchanger;
an expander portion of a gas turbine in operational communication with a generator, and in electrical communication with the motor;
a natural gas supply in fluid communication with the gas turbine.

2. The combine cycle gas turbine system of claim 1, wherein the natural gas supply is also in fluid communication with the gas-fired heater.

3. A combined cycle system comprising:
a liquid air storage tank in fluid communication with a pump;
a first heat exchanger in fluid communication with the pump;
a second heat exchanger in fluid communication with the first heat exchanger;
a cryogenic expander in fluid communication with the first heat exchanger;
a third heat exchanger in fluid communication with the second heat exchanger;
a fifth heat exchanger in fluid communication with the second heat exchanger and the third heat exchanger;
a first compressor in fluid communication with the second heat exchanger;
a second compressor in fluid communication with the second heat exchanger and the cryogenic expander and the fifth heat exchanger;
an inter-cooler in fluid communication with both the first compressor and second compressor;
an exhaust flue in fluid communication with the third heat exchanger;
a fourth heat exchanger in fluid communication with the third heat exchanger, and the fifth heat exchanger;
a hot gas expander comprising a first stage hot gas expander and a second stage hot gas expander, the first stage hot gas expander in fluid communication with the third heat exchanger and the fourth heat exchanger, and the second stage hot gas expander in fluid communication with the third heat exchanger;
a prime mover in fluid communication with the fourth heat exchanger;
a driven piece of equipment in operational communication with the prime mover;
a natural gas supply in fluid communication with the prime mover; and
the cryogenic expander in operable communication with the first compressor and the second compressor.

4. The combined cycle system of claim 3, further comprising:
a generator in operable communication with the gas turbine.

5. The combined cycle system of claim 3, wherein:
the cryogenic expander is in operable communication with the first compressor and in operable communication with the second compressor.

6. The combined cycle system of claim 3, wherein:
the cryogenic expander shares the same drive shaft with the first compressor and the second compressor.

7. The combined cycle system of claim 3, wherein:
the hot gas expander is in operational communication with a piece of driven machinery.

8. The combined cycle system of claim 7 wherein the piece of driven machinery is a generator.

9. The combined cycle gas turbine system of claim 3, wherein the thermal efficiency of the combined cycle gas turbine system is about 60%.

10. A combined cycle power plant comprising:
a first cycle comprising:
a prime mover;
a prime mover exhaust in fluid communication with the prime mover;
a second cycle comprising:
a liquid air supply;
a heat exchanger in fluid communication with the liquid air supply and the prime over exhaust;
a turbo expander in fluid communication with the heat exchanger;
wherein liquid air is heated to gaseous air by the heat exchanger, and the gaseous air is expanded in the turbo expander thereby producing work.

11. A liquid air combined cycle method comprising:
providing pressurized liquid air;
heating the pressurized liquid air to pressurized gaseous air;
expanding the pressurized gaseous air with a turbo expander;
using work from the expansion of the pressurized gaseous air to compress ambient air;
heating the expanded pressurized gaseous air;
sending the heated expanded air to a turbine combustion chamber; and
using waste heat from a turbine to heat pressurized liquid air.

12. A liquid air combined cycle method comprising:
providing pressurized liquid air;
heating the pressurized liquid air to pressurized gaseous air;
expanding the pressurized gaseous air with a turbo expander;
using work from the expansion of the pressurized gaseous air to drive a generator; and
using waste heat from a prime mover to heat pressurized liquid air.
